(19) United States
(12) Patent Application Publication
(10) Pub. No.: US 2010/0231617 A1
(43) Pub. Date: Sep. 16, 2010

(54) DATA PROCESSING DEVICE, LIQUID CRYSTAL DISPLAY DEVCE, TELEVISION RECEIVER, AND DATA PROCESSING METHOD

(76) Inventors: Yoichi Ueda, Osaka (JP); Fumikazu Shimoshikiryoh, Osaka (JP); Kentarou Irie, Osaka (JP)

Correspondence Address: HARNESS, DICKEY & PIERCE, P.L.C., P.O. BOX 8910, RESTON, VA, 20195, US

(21) Appl. No.: 12/734,320

(22) PCT Filed: Sep. 3, 2008
(86) PCT No.: PCT/JP2008/065839

§ 371 Date: Apr. 23, 2010

(30) Foreign Application Priority Data
Nov. 8, 2007 (JP) 2007-290867
Jul. 25, 2008 (JP) 2008-192237

(51) Int. Cl. G09G 3/36; G09G 5/10

(52) U.S. Cl. 345/690; 345/87

(57) ABSTRACT

According to a data processing device for correcting an image signal which (i) is made up of plural pieces of pixel data and (ii) is externally supplied to a liquid crystal driving panel, a correction circuit includes an interpolation section for (i) obtaining first pixel data to be corrected and second pixel data which is for use in driving one of the plurality of data signal lines at timing earlier than timing at which the one of the plurality of data signal lines is driven in response to the first pixel data and (ii) correcting the first pixel data in accordance with a relationship between the second pixel data and the first pixel data. This provides a data processing device which can carry out a correction so that, in a case where a previously applied voltage have an effect on the charging states of respective pixels connected to a certain data signal line, such an effect is cancelled.

### TECHNICAL FIELD

The present invention relates to (i) a data processing device for correcting an image signal to be externally supplied to a liquid crystal display device, which displays an image in response to a voltage applied to liquid crystal, and (ii) a liquid crystal display device.

### BACKGROUND ART

A liquid crystal display device is a planar display device which has excellent features such as high-precision, thin, light, and low power-consumption. The market of the liquid crystal display device has been rapidly expanded because of improvements in (i) display quality, (ii) production capacity, and (iii) price competitiveness over other display devices.

FIG. 19 illustrates a configuration of a conventional liquid crystal display device disclosed in Patent Literature 1. The conventional liquid crystal display device includes: a horizontal shift resister circuit 110; a sample-hold circuit 111 for image signals; a vertical shift resister circuit 113 and a vertical output buffer 114; a pre-charge circuit 112 and a pixel TFT display region 115 for displaying an image; a plurality of scanning signal lines which are connected to the vertical output buffer 114; and a plurality of image signal lines which intersect with the plurality of scanning lines so that the plurality of image signal lines and the plurality of scanning lines define a plurality of lattice regions. The plurality of image signal lines are connected to the sample-hold circuit 111 and the pre-charge circuit 112. Each of the plurality of image signal lines is provided with a transfer gate at one end of the sample-hold circuit 111 side and a transfer gate at the other end of a pre-charge circuit 112 side.

A transfer clock which is generated by a timing generator 118 is supplied, as a drive signal supplied from a peripheral driving circuit, to the above circuit elements of the liquid crystal display device. The sample-hold circuit 111 receives a video signal for driving liquid crystal, which video signal is generated, via a 1H line memory circuit 119, by an alternating current reversal/amplification circuit 116. The sample-hold circuit 111 then outputs the video signal so that its polarity is reversed every horizontal scanning period. Further, the pre-charge circuit 112 receives a pre-charge signal, which is generated by a pre-charge signal generating circuit 117 in response to a level of the video signal externally supplied via a pre-charge level detection circuit 120.

If the transfer gates of the sample-hold circuit 111 are not uniform and the transfer gates of the pre-charge circuit 112 are not uniform, in terms of their transistor characteristics, then their abilities to charge the respective plurality of image signal lines will not be uniform. It follows that voltages actually written to pixels become different from one another. The pre-charge circuit 112 supplies the pre-charge signals to the respective plurality of image signal lines so as to correct such abilities to charge the respective plurality of image signal lines. More specifically, a pre-charge signal is supplied to a corresponding one of the plurality of image signal lines in advance so as to increase and keep an electric potential of the corresponding one of the plurality of image signal lines. The pixels are further charged during a subsequent actual charging period. Since the pixels are pre-charged in response to the pre-charge signal, it is possible to charge the pixels more quickly. Further, different pre-charge signals are supplied to the respective plurality of image signal lines, so that non-uniformabilities to charge the respective plurality of image signal lines are corrected. Accordingly, it is possible to cause a display screen to carry out a uniform display.

### Citation List

Patent Literature 1

Japanese Patent Application Publication, Tokukai, No. 2002-351427 A (Publication Date: Dec. 6, 2002)

### SUMMARY OF INVENTION

On the other hand, the pixels can be more quickly charged by employing a driving method for broadening a pulse width of a gate-on pulse causing a corresponding one of the plurality of scanning signal lines to be placed in a selected state. FIG. 20 is a timing chart obtained when a display is carried out by using the above driving method. FIG. 20 is the timing chart for a certain data signal line, and illustrates (a) timing at which data [i] in an image signal DATA is displayed, (b) a source voltage indicative of an electric potential of the image signal DATA applied to the certain data signal line, (c) a gate voltage [i] indicative of an electric potential of a gate signal applied to an i-th horizontal scanning line, and (d) an electrode voltage [i] indicative of an electric potential of a pixel electrode connected to the i-th horizontal scanning line.

As is clear from FIG. 20, the gate voltage [i] has a gate-on pulse whose rising edge comes earlier than a horizontal scanning period starts during which the data [i] is to be displayed. This indicates that the gate-on pulse includes both a pre-charge period and an actual charge period. Since a gate of a TFT is thus placed in an active state prior to an actual horizontal scanning period, a period, during which the pixel electrodes are charged, is prolonged. Since the pixel electrodes are pre-charged during the pre-charge period, it is possible for the pixel electrodes to be surely charged, within the actual charge period, so as to have a target electric potential, even in a case where the need arises to shorten the horizontal scanning period so as to increase scanning frequency, for example.

It should be noted that an interlacing scanning is employed in this method. Therefore, the image signal DATA is supplied every other horizontal scanning line. That is, the image signal DATA is outputted such that data [n−2], data [n], data [n+2], . . . data [n−1], data [n+1], and so on are sequentially outputted from the display control circuit 2.

The image signal DATA of FIG. 20 is illustrated on an assumption that data corresponding to an n-th gate line only causes a black display, and data corresponding to each of the other gate lines causes a predetermined halftone display (a gray display). For such an image signal data, the pre-charge period during which the pixel electrodes corresponding to an (n+2)-th gate line are charged is affected by the black display caused by the data corresponding to an n-th gate line. As a result, target charging cannot be achieved.

If this occurs, pixels corresponding to the (n+2)-th gate line cause a gray color display, which is darker than a target gray color display (see FIG. 21). This causes a display defect called “ghost”. The ghost is outstanding especially when the display is carried out by the interlacing scanning.

Meanwhile, Patent Literature 1 further discloses a configuration including pre-charge signal output means, which outputs a pre-charge signal of a predetermined level to an (N+1)-th scanning signal line. The pre-charge signal output means determines the level of the pre-charge signal based on a level of an image signal corresponding to an (N−m)-th or (N+n)-th (m is an integer satisfying an inequality N>m>0, and n is an integer satisfying an inequality n>1) scanning signal line.

However, according to the configuration, the level of the pre-charge signal is determined based only on the level of the image signal corresponding to a certain scanning signal line. As such, the configuration cannot prevent the above ghost from occurring.

The present invention has been made in view of the problems, and an object of the present invention is to (i) provide a data processing device and a data processing method each of which (a) corrects an image signal made up of plural pieces of pixel data which are externally supplied to a liquid crystal driving panel, and (b) can carry out a correction so that, in a case where a previously applied voltage have an effect on the charging states of respective pixels connected to a certain data signal line, such an effect is cancelled, (ii) provide a liquid crystal display device including the data processing device, and (iii) provide a television receiver including the data processing device.

In order to solve the above problem, a data processing device of the present invention for correcting an image signal which (i) is made up of plural pieces of pixel data and (ii) is externally supplied to an active matrix liquid crystal driving panel, the active matrix liquid crystal driving panel including: a plurality of scanning signal lines extending in a line direction; a plurality of data signal lines extending in a column direction; and a plurality of pixels provided for respective intersections of the plurality of the scanning signal lines and the plurality of data signal lines, said data processing device, including: a correction processing section for (i) obtaining first pixel data to be corrected and second pixel data which is for use in driving one of the plurality of data signal lines at timing earlier than timing at which the one of the plurality of data signal lines is driven in response to the first pixel data and (ii) correcting the first pixel data in accordance with a relationship between the second pixel data and the first pixel data.

A data processing method according to the present invention for correcting an image signal which (i) is made up of plural pieces of pixel data and (ii) is externally supplied to an active matrix liquid crystal driving panel, the active matrix liquid crystal panel including: a plurality of scanning signal lines extending in a line direction; a plurality of data signal lines extending in a column direction; and a plurality of pixels provided for respective intersections of the plurality of the scanning signal lines and the plurality of data signal lines, said method including the steps of: obtaining first pixel data to be corrected and second pixel data which is for use in driving one of the plurality of data signal lines at timing earlier than timing at which the one of the plurality of data signal lines is driven in response to the first pixel data; and correcting the first pixel data in accordance with a relationship between the second pixel data and the first pixel data.

According to the active matrix liquid crystal driving panel as described earlier, each of the plurality of data signal lines receives, for every horizontal scanning period, a voltage which corresponds to pixel data and is to be applied in a corresponding horizontal scanning period. Therefore, depending on a drive state, a previously applied voltage may have an effect on charging states of respective pixels.

In contrast, according to the above configuration or above method, the pixel data is corrected in accordance with the relationship between (i) the first pixel data and (i) the second pixel data which is for use in driving one of the plurality of data signal lines at timing earlier than timing at which the one of the plurality of data signal lines is driven in response to the first pixel data. This makes it possible to carry out a correction so that, in a case where a previously applied voltage have an effect on the charging states of respective pixels connected to a certain data signal line, such an effect is cancelled. As such, it is possible to cause the liquid crystal driving panel to carry out a high-quality display which is faithful to the original image signal.

The data processing device can be configured so as to further include: a buffer for storing (i) the first pixel data to be corrected and the second pixel data which is for use in driving one of the plurality of data signal lines at timing earlier than timing at which the one of the plurality of data signal lines is driven in response to the first pixel data, the correction processing section obtaining the first pixel data and the second pixel data from the buffer.

The data processing device according to the present invention can be configured such that the liquid crystal driving panel charges corresponding ones of the plurality of pixels during (i) an actual charge period during which one of the plurality of scanning signal lines is being selectively driven so that corresponding ones of the plurality of pixels each receive, based on the first pixel data, a voltage from the one of the plurality of data signal lines, and (ii) a pre-charge period during which the one of the plurality of scanning signal lines is being selectively driven and which pre-charge period comes earlier than the actual charge period, and the second pixel data is data to be used when the one of the plurality of data signal lines is driven during the pre-charge period.

According to the configuration, the corresponding ones of the plurality of pixels are charged during the actual charging period and the pre-charge period. Since the corresponding ones of the plurality of pixels are pre-charged during the pre-charge period, it is possible for the corresponding ones of the pixels to be surely charged, within the actual charge period, so as to have a target electric potential, even in a case where the need arises to shorten the horizontal scanning period so as to increase scanning frequency, for example.

In a case where the corresponding ones of the plurality of pixels are charged during the actual charge period and the pre-charge period, the charge states of the corresponding ones of the plurality of pixels, during the actual charge period, may change depending on a relationship between (i) a voltage applied to the one of the plurality of data signal lines during the pre-charge period and (ii) a voltage applied to the one of the plurality of data signal lines during the actual charge period. However, according to the configuration, the first pixel data is corrected in accordance with the relationship between (i) the first pixel data and (ii) the second pixel data which is data to be used when the one of the plurality of data signal lines is driven during the pre-charge period. This makes it possible to stabilize the charging states of the corresponding ones of the plurality of pixels during the actual charge period. As such, it is possible to cause the liquid crystal driving panel to carry out a high-quality display which is faithful to the original image signal.

The data processing device of the present invention can be configured such that the liquid crystal driving panel is driven by an interlacing scanning in which (i) the plurality of scanning signal lines are divided into two groups so as to belong to an identical group every other horizontal scanning line and (ii) the two groups are sequentially scanned, and the second pixel data is data to drive pixels corresponding to a (n−2)-th scanning signal line, where a scanning signal line is an n-th scanning signal line corresponding to pixels which are driven in response to the first pixel data.

In a case where the liquid crystal driving panel is driven by the interlacing scanning as above, each of the plurality of data signal lines sequentially receives (i) a drive voltage to be applied to a pixel corresponding to the (n−2)-th scanning signal line and (ii) a drive voltage to be applied to a pixel corresponding the n-th scanning signal line. Therefore, depending on a drive condition, the voltage applied to the pixel corresponding to the (n−2)-th scanning signal line may have an effect on a charging state of the pixel corresponding to the n-th scanning signal line. If this is the case, an abnormal display occurs in a horizontal scanning line (n-th scanning signal line) after the subsequent horizontal scanning line ((n−1)-th scanning signal line). This phenomenon is called “ghost”, which deteriorates display quality.

In contrast, according to the configuration, the first pixel data is corrected in accordance with the relationship between (i) the second pixel data corresponding to the (n−2)-th scanning signal line and (ii) the first pixel data corresponding to the n-th scanning signal line. This makes it possible to prevent the ghost from occurring. As such, it is possible to cause the liquid crystal driving panel to carry out a high-quality display which is faithful to the original image signal.

The data processing device according to the present invention can be configured so as to further include a correction amount storage section for storing correction amount data each corresponding to a combination of the second pixel data and first pixel data, the correction processing section carrying out a correction with reference to the correction amount data stored in the correction amount storage section.

According to the configuration, the data processing device includes the correction amount storage section which stores the correction amount data each corresponding to a combination of the second pixel data and the first pixel data. The correction amount storage section stores the correction amount data in advance so that, in a case where a previously applied voltage have an effect on the charging states of respective pixels connected to a certain data signal line, such an effect is cancelled. This makes it possible to carry out an appropriate correction.

In most cases, such a correction amount is difficult to find by using a function with respect to the second pixel data and the first pixel data. Therefore, it is preferable to determine the correction amount by using the correction amount storage section as above.

The data processing device according to the present invention can be configured such that the amount storage section stores the correction amount data which correspond to combinations of a plurality of representative gray scale levels corresponding to the second pixel data and a plurality of representative gray scale levels corresponding to the first pixel data, and the correction processing section finds a correction amount by (i) identifying, out of the plurality of representative gray scale levels corresponding to the second pixel data, two representative gray scale levels between which the second pixel data obtained is positioned, (ii) identifying, out of the plurality of representative gray scale levels corresponding to the first pixel data, two representative gray scale levels between which the first pixel value obtained is positioned, and (iii) carrying out an interpolation with respect to correction amount data corresponding to combinations of the two representative gray scale levels for the second pixel data and the two representative gray scale levels for the first pixel data.

According to the configuration, the correction amount storage section stores the correction amount data which correspond to respective combinations of the plurality of representative gray scale levels. This makes it possible to reduce a required memory size as compared to a case where the correction amount storage section stores the correction amount data corresponding to respective combinations of all the gray scale levels. Further, since the correction processing section finds the correction amount by carrying out the interpolation, it is possible to determine the correction amount with relatively high precision, even if the first pixel data and the second pixel data do not match any of the representative gray scale levels. That is, according to the configuration, it is possible to reduce the memory size of the correction amount storage section while keeping precision of the settings of the correction amount. Accordingly, it is possible to achieve a cost reduction.

A liquid crystal display device according to the present invention includes: an active matrix liquid crystal driving panel including: a plurality of scanning signal lines extending in a line direction, a plurality of data signal lines extending in a column direction, and a plurality of pixels provided for respective intersections of the plurality of scanning signal lines and the plurality of data signal lines; a scanning signal driving section for sequentially applying a gate-on pulse to the plurality of scanning signal lines so as to selectively drive the plurality of scanning signal lines; a data signal driving section for applying a data signal to the plurality of data signal lines so that polarity of the data signal is reversed for every predetermined number of horizontal periods during one frame period; and a data processing device according to the present invention.

According to the configuration, it is possible to carry out a correction so that, in a case where a previously applied voltage have an effect on the charging states of respective pixels connected to a certain data signal line, such an effect is canceled. This makes it possible to carry out a high-quality display which is faithful to the original image signal.

The liquid crystal display device according to the present invention can be configured so as to further include: a display control circuit for (i) receiving an image signal which is made up of plural pieces of pixel data and is externally supplied and (ii) outputting (a) signals for controlling operations of the scanning signal driving section and the data signal driving section and (b) an image signal to be supplied to the data signal driving section, the data processing device correcting the image signal outputted from the display control circuit so as to supply a corrected image signal to the data signal driving section.

According to the configuration, the correction is carried out with respect to the image signal supplied from the display control circuit. Therefore, for example in a case where the liquid crystal display device is configured such that the image signal is corrected by, for example, a gamma correction in the display control circuit, it is still possible to provide, to the data signal driving section, the image signal that is appropriately corrected by the data processing device.

The liquid crystal display device according to the present invention can be configured so as to further include: a display control circuit for (i) receiving an image signal which is made up of plural pieces of pixel data and is externally supplied and (ii) outputting (a) signals for controlling operations of the scanning signal driving section and the data signal driving section and (b) a image signal to be supplied to the data signal driving section, the data processing device correcting the image signal supplied to the display control circuit.

According to the configuration, the data processing device is provided so that signals are supplied to the data processing device and thereafter to the display control circuit. Therefore, it is not necessary to restructure a conventional circuit configuration and circuit layout which involve circuits from the display control circuit to the data signal driving circuit. As such, it is possible to achieve simple configuration even in a case where the data processing device is additionally provided.

The liquid crystal display device according to the present invention can be configured such that the display control circuit carries out a gamma correction independently for each color component of the image signal, the liquid crystal display device further including: a correction amount storage section for storing, independently for each color component, correction amount data corresponding to a combination of second pixel data and first pixel data, the correction amount storage section carrying out correction with reference to the correction amount data stored in the correction amount storage section.

According to the configuration, it is possible to appropriately compensate for, for each color component, wavelength dependence of a relationship between the voltage applied to the liquid crystal layer and the optical transmittance. This makes it possible to improve the display quality. Further, the correction processing section in the data processing device carries out the correction with reference to the correction amount data, stored independently for each color component, in the correction amount storage section. That is, it is possible to store the correction amount data as correction amounts determined in consideration of the gamma correction that is carried out for each color component. As such, it is possible to appropriately achieve advantages of both the correction performed by the data processing device and the independent gamma correction.

Further, it is possible to configure a television receiver including a liquid crystal display device according to the present invention and a tuner section for receiving television broadcasting.

### BRIEF DESCRIPTION OF DRAWINGS

FIG. 1 is a block diagram schematically illustrating a liquid crystal display device according to an embodiment of the present invention.

FIG. 2 is a block diagram schematically illustrating a correction circuit.

FIG. 3 illustrates an example of a memory configuration of an LUT.

FIG. 4 illustrates a specific example of the memory configuration of the LUT.

FIG. 5 is a flowchart illustrating a flow of a process performed in the correction circuit.

FIG. 6 is a timing chart for a specific driving example, illustrating (i) an image signal DATA, (ii) a source voltage indicative of an electric potential of the image signal DATA applied to a data signal line, (iii) a gate voltage indicative of an electric potential of a gate signal, and (iv) an waveform of an electrode voltage indicative of an electric potential of a pixel electrode.

FIG. 7 is a timing chart obtained when pieces of data which make up the image signal DATA are supplied every other horizontal scanning line by an interlacing scanning, illustrating (a) a gate clock and (b) a gate voltage indicative of an electric potential of a gate signal applied to an i-th horizontal scanning line.

FIG. 8 is a timing chart obtained when driving is carried out by a progressive scanning, illustrating (i) an image signal DATA, (ii) a source voltage indicative of an electric potential of the image signal DATA applied to a data signal line, (iii) a gate voltage indicative of an electric potential of a gate signal, and (iv) an waveform of an electrode voltage indicative of an electric potential of a pixel electrode.

FIG. 9 is a timing chart obtained when driving is carried out by the progressive scanning with a line inversion driving, illustrating a gate voltage indicative of an electric potential of a gate signal applied to an i-th horizontal scanning line.

FIG. 10 is a block diagram illustrating a configuration of a display device applied to a television receiver.

FIG. 11 is a block diagram illustrating how a tuner section and the display device are connected.

FIG. 12 is an exploded perspective view illustrating an example of a mechanical composition of a television receiver including the display device.

FIG. 13(a) of FIG. 13 is a block diagram schematically illustrating a configuration in which a correction circuit corrects an image signal supplied from a display control circuit. (b) of FIG. 13 is a block diagram schematically illustrating a configuration in which the correction circuit corrects a digital video signal externally supplied and then outputs the corrected digital video signal to the display control circuit.

FIG. 14 is a block diagram schematically illustrating a configuration of an independent gamma correction section.

FIG. 15 illustrates a specific example of an LUT for an independent gamma.

FIG. 16(a) of FIG. 16 illustrates an example of numeric values obtained when a ghost correction only is carried out with respect to image data corresponding to n-th and (n+2)-th lines, without carrying out the independent gamma correction. (b) of FIG. 16 illustrates an example of numeric values obtained when the independent gamma correction and the ghost correction are carried out in this order with respect to the image data corresponding to the n-th and (n+2)-th lines. (c) of FIG. 16 illustrates an example obtained when the ghost correction and the independent gamma correction are carried out in this order with respect to the image data corresponding to the n-th and (n+2)-th lines.

FIG. 17 illustrates an example of an LUT provided in the correction circuit.

FIG. 18 is a block diagram illustrating a configuration of a correction circuit, which includes LUTs corresponding to color components of red, green, and blue, respectively.

FIG. 19 is a block diagram illustrating a configuration of a conventional liquid crystal display device.

FIG. 20 is a timing chart obtained when pixels are charged more quickly by a driving method, whereby to broaden a pulse width of each gate-on pulse which selectively drives scanning signal lines.

FIG. 21 illustrates an example of a display screen where a ghost is observed.

### REFERENCE SIGNS LIST

1 Liquid Crystal Display Device
2 Display Control Circuit
3 Source Driver
4 Gate Driver
10 Correction Circuit (Data Processing Device)
11 Buffer
12, 12R, 12G, and 12B LUT (Correction Amount Memory Section)
13 Interpolation Section (Correction Processing Section)
14 Correction Amount Storage Section
15 Adder
21 Independent Gamma Correction Processing Section
22 Independent Gamma LUT
24 Liquid Crystal Driving Panel
25 Backlight
80 Y/C Separation Circuit
81 Video Chroma Circuit
82 A/D Converter
83 Liquid Crystal Controller
84 Liquid Crystal Panel
85 Backlight Driving Circuit
86 Backlight
87 Microcomputer
88 Gray Scale Circuit
90 Tuner Section
100 TFT
800 Display Device
801 First Housing
801a Opening
805 Operation Circuit
806 Second Housing
808 Supporting Member

### DESCRIPTION OF EMBODIMENTS

One embodiment of the present invention is described below with reference to the attached drawings.

### (Overall Configuration of Liquid Crystal Display Device)

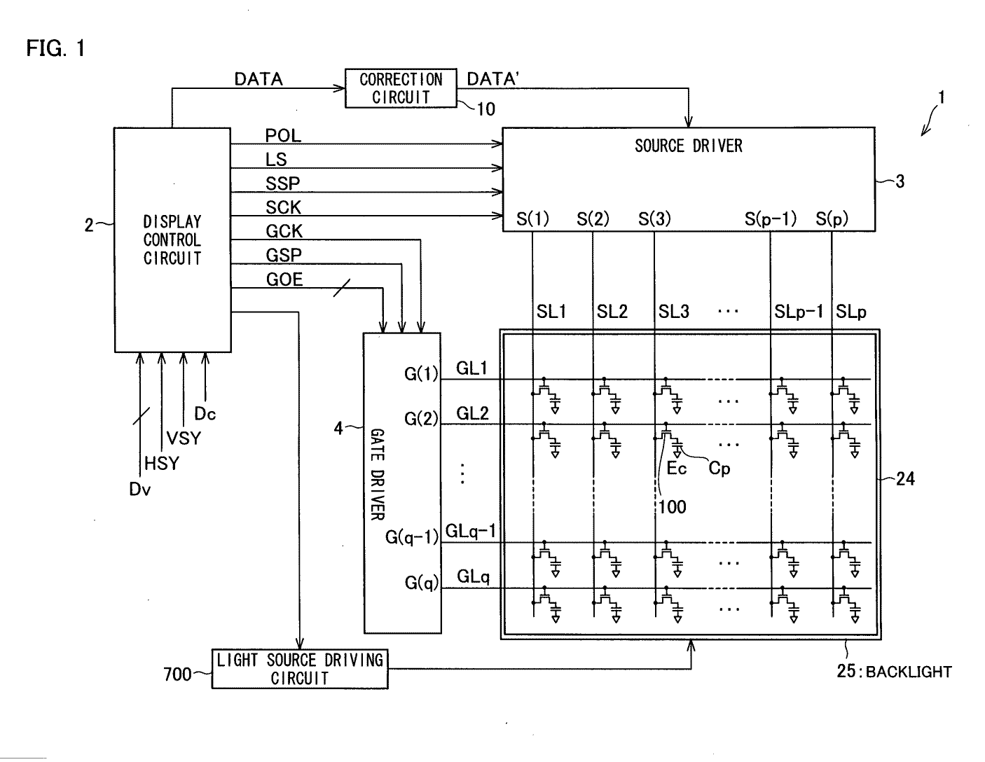

FIG. 1 is a block diagram schematically illustrating a configuration of a liquid crystal display device 1 according to the present embodiment. The liquid crystal display device 1 includes: a source driver 3 serving as a data signal line driving circuit; a gate driver 4 serving as a scanning signal line driving circuit; an active matrix liquid crystal driving panel 24; a backlight 25 serving as a planar lighting system; a light source driving circuit 700 for driving the backlight 25; a display control circuit 2 for controlling the source driver 3, gate driver 4, and the light source driving circuit 700; and a correction circuit (data processing device) 10 for correcting an image signal DATA supplied from the display control circuit 2. According to the present embodiment, the liquid crystal driving panel 24 is realized by the active matrix liquid crystal driving panel. Alternatively, the liquid crystal driving panel 24 can be arranged so that the liquid crystal driving panel 24, the source driver 3, and the gate driver 4 are integral with each other.

The liquid crystal driving panel 24 of the liquid crystal display device 1 includes: gate lines GL1 through GLq serving as a plurality of scanning signal lines (q scanning signal lines); source lines SL1 through SLp intersecting with the gate lines GL1 through GLq and serving as a plurality of data signal lines (p data signal lines); and a plurality of pixel formation sections ((p×q) pixel formation sections) provided so as to correspond to respective intersections of the gate lines GL1 through GLq and the source lines SL1 through SLp. The plurality of pixel formation sections are provided in a matrix manner so as to form a pixel array. Hereinafter, a direction in which the gate lines of the pixel array extend is referred to as a line direction, and a direction in which the source lines of the pixel array extend is referred to as a column direction.

Each of the plurality of pixel formation sections includes: (i) a TFT 100, which is a switching element, having (a) a gate terminal which is connected with a gate line GLj passing through a corresponding one of the intersections and (b) a source terminal which is connected with a source line SLi passing through the corresponding one of the intersections; (ii) a pixel electrode which is connected with a drain terminal of the TFT 100; (iii) a common electrode Ec which is a counter electrode shared by the plurality of pixel formation sections; and (iv) a liquid crystal layer which is shared by the plurality of pixel formation sections and is sandwiched between the pixel electrode and the common electrode Ec. Moreover, a pixel capacitance Cp is made up of a liquid crystal capacitance defined by the pixel electrode and the common electrode Ec. Generally, a storage capacitor (retention capacitor) is additionally provided in parallel with the liquid crystal capacitance so as to surely hold a voltage across the pixel capacitance. However, the description and illustration of the storage capacitor are omitted here because the storage capacitor is not directly related to the present embodiment.

In each of the plurality of pixel formation sections, (i) the pixel electrode receives, from the source driver 3 and the gate driver 4, an electric potential corresponding to an image to be displayed and (ii) the common electrode Ec receives a predetermined electric potential Vcom from a power source circuit (not illustrated). This causes an electric potential difference between the pixel electrode and the common electrode Ec, and thus a voltage corresponding to the electric potential difference is applied to the liquid crystal layer. The voltage thus applied controls an amount of light transmitting the liquid crystal layer, so that an image display is carried out.

The present embodiment assumes a VA (vertical alignment) liquid crystal display device. In the VA liquid crystal display device, while no voltage is applied, liquid crystal molecules provided between substrates are aligned so as to be substantially vertical with respect to surfaces of the substrates. In this state of the liquid crystal display device, the light having entered the liquid crystal layer has a polarization plane that is scarcely rotated. On the other hand, while a voltage is being applied, the liquid crystal molecules are oriented at angles with respect to a direction vertical to the surfaces of the substrates. The angles depend on a level of the voltage. In this state of the liquid crystal display device, the light having entered the liquid crystal layer has a polarization plane that is rotated. Under the circumstances, provision of two polarization plates achieves a normally black display, in which a black display is caused while no voltage is applied whereas a white display is caused while a voltage is being applied. The two polarization plates are provided, respectively, on a light-entering side and on a light-emitting side of the liquid crystal display device so that their polarizing axes are in a crossed Nicoles relation.

Note, however, that the present invention is not limited to such a VA liquid crystal display device, and is therefore applicable to a TN (Twisted Nematic) liquid crystal display device. Further, the present invention is not limited to the normally black display, and is therefore applicable to a normally white display.

The backlight 25 is a planar lighting system, which backlights the liquid crystal drive panel 24. The backlight 25 is constituted by, for example, (i) cold cathode fluorescent tubes each serving as a linear light source and (ii) light guide plates. The light source driving circuit 700 drives the backlight so as to turn on the backlight 25. This causes irradiation of the plurality of pixel formation sections in the liquid crystal drive panel 24.

The display control circuit 2 receives, from external signal sources, a digital video signal Dv indicative of an image to be displayed; a horizontal sync signal HSY and a vertical sync signal VSY which correspond to the digital video signal Dv; and a control signal Dc for controlling a display operation. Further, in response to the signals Dv, HSY, VSY and Dc, the display control circuit 2 generates and outputs the following signals which cause the image, corresponding to the digital video signal Dv, to be displayed: a data start pulse signal SSP; a data clock signal SCK; a latch strobe signal (a data signal application control signal) LS; a polarity reverse signal POL; an image signal DATA corresponding to an image to be displayed (equivalent to the video signal Dv); a gate start pulse signal GSP; a gate clock signal GCK; and a gate driver output control signal (a scanning signal output control signal) GOE.

Out of the signals thus generated by the display control circuit 2, the latch strobe signal LS, the data start pulse signal SSP, the data clock signal SCK, and the polarity reverse signal POL are supplied to the source driver 3, whereas the gate start pulse signal GSP, the gate clock signal GCK, and the gate driver output control signal COE are supplied to the gate driver 4. Further, the image signal DATA is supplied to the correction circuit 10.

The correction circuit 10 corrects the image signal DATA supplied from the display control circuit 2 so as to supply a corrected image signal DATA′ to the source driver 3. The correction circuit 10 is provided outside the display control circuit 2 in FIG. 1. Instead, the correction circuit 10 can be provided inside the display control circuit 2. A configuration and a correction process of the correction circuit 10 are described later in detail.

The source driver 3 sequentially generates, for every horizontal period, analog voltages which are equivalent to pixel values corresponding to the respective horizontal scanning lines for an image corresponding to the corrected image signal DATA′. The analog voltages are data signals S(1) through S(p), which are generated in response to the corrected image signal DATA′, the data start pulse signal SSP and the data clock signal SCK, the latch strobe signal LS, and the polarization reverse signal POL. The data signals S(1) through S(p) are applied to the source lines SL1 through SLn, respectively.

The gate driver 4 generates scanning signals G(1) through G(q) in response to the gate start pulse signal GSP (GSPa and GSPb) and the gate clock signal GCK (GCKa and GCKb), and the gate driver output control signal GOE (GOEa and GOEb). The gate driver 4 then applies the scanning signals G(1) through G(q) to the gate lines GL1 through GLq, respectively, so as to selectively drive the gate lines GL1 through GLq.

The source lines SL1 through SLp and the gate lines GL1 through GLq of the liquid crystal driving panel 24 are driven by the source driver 3 and the gate driver 4, respectively, as above. This causes corresponding pixel capacitors Cp to receive a voltage from the source line SLi via a corresponding one of the TFTs 100, which are connected with a selected gate line GLj (i=1 to p, and j=1 to q). As such, a voltage corresponding to the corrected image signal DATA′ is applied to the liquid crystal layer in each of the plurality of pixel formation sections. In response to the voltage applied, the amount of light of the backlight 25 transmitting the liquid crystal layer is controlled. This causes the image, which corresponds to the digital video signal Dv externally supplied, to be displayed on the liquid crystal driving panel 24.

The display can be carried out by a progressive scanning or an interlacing scanning. According to the progressive scanning, the gate lines GL1 through GLq are sequentially scanned, for every horizontal scanning line, from the top to the bottom so as to display one screen (i.e., during one frame period).

On the other hand, according to the interlacing scanning, (i) the gate lines GL1 through GLq are divided into a plurality of groups so as to belong to an identical group every given horizontal scanning line(s) and (ii) scanning is sequentially carried out with respect to each of the plurality of groups. For example, in a case where the gate lines GL1 through GLq are divided into two groups so as to belong to an identical group every other horizontal scanning line, (i) ones of odd numbered gate lines or even numbered gate lines out of the gate lines GL1 through GLq are sequentially scanned from the top to the bottom, and (ii) then the other ones are sequentially scanned from the top to the bottom, during one (1) frame period.

The present invention is applicable to either the progressive scanning or the interlacing scanning. The following embodiment first deals with a case of employing the interlacing scanning, in which the scanning is carried out every other horizontal scanning line.

### (Configuration of Correction Circuit)

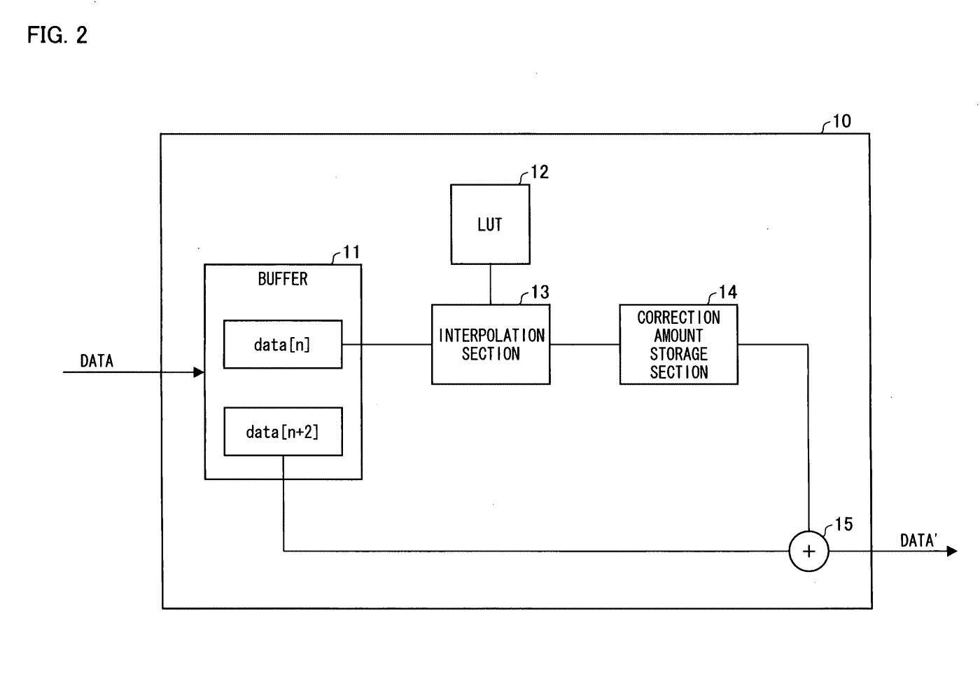

The description is given below as to configuration of the correction circuit 10 with reference to FIG. 2. As illustrated in FIG. 2, the correction circuit 10 includes: a buffer 11; an LUT (lookup table) (correction amount memory section) 12; an interpolation section (correction processing section) 13; a correction amount storage section 14; and an adder 15.

The buffer 11 temporarily stores image signal DATA corresponding to at least two horizontal scanning lines. In the case of the interlacing scanning, in the image signal DATA, (i) plural pieces of data for ones of the odd numbered or even numbered horizontal scanning lines are followed by (ii) plural pieces of data for the other ones of the odd numbered or even numbered horizontal scanning lines. Specifically, the image signal DATA is stored in the buffer 11 such that data (data [n]) corresponding to an n-th horizontal scanning line and data (data [n+2]) corresponding to an (n+2)-th horizontal scanning line are sequentially supplied to and stored in the buffer 11 in this order.

The interpolation section 13 reads out, from the buffer 11 which stores data corresponding to two horizontal scanning lines, two pieces of pixel data corresponding to a particular data signal line. Then, the interpolation section 13 carries out an interpolation with reference to the LUT 12 so as to find a correction amount. For example, in the case of the interlacing scanning, the interpolation section 13 reads out, from the buffer 11, (i) pixel data in the data [n] which corresponds to the particular data signal line and (ii) pixel data in the data [n+2] which corresponds to the particular data signal line. Then, the interpolation section 13 carries out the interpolation with reference to the LUT 12 so as to find a correction amount for correcting the pixel data in the data [n+2]. The interpolation is described later in detail.

The LUT 12 stores information relating to a relationship between (i) the respective plural pieces of data, corresponding to the two horizontal scanning lines, which are stored in the buffer 11 and (ii) respective correction amounts. Specifically, the LUT is constituted by a two-dimensional memory, which stores a correction amount corresponding to a combination of (a) a value of the data [n] to be referred to, and (b) a value of the data [n+2] to be corrected.

The correction amount storage section 14 temporarily stores the correction amount found by the interpolation section 13. The adder 15 adds (i) the correction amount supplied from the correction amount storage section 14 and (ii) pixel data corresponding to the above correction amount supplied from the buffer 11. Specifically, the correction amount is first supplied to the adder 15 from the interpolation section 14. Then, the pixel data in the data [n+2], which was used in finding the correction amount, is supplied to the adder 15 from the buffer 11. Then, the adder 15 carries out an addition of the correction amount to the pixel data, and then outputs the addition. This process is sequentially carried out with respect to each pixel so as to ultimately cause the correction circuit 10 to output the corrected image signal DATA′.

### (Configuration of LUT)

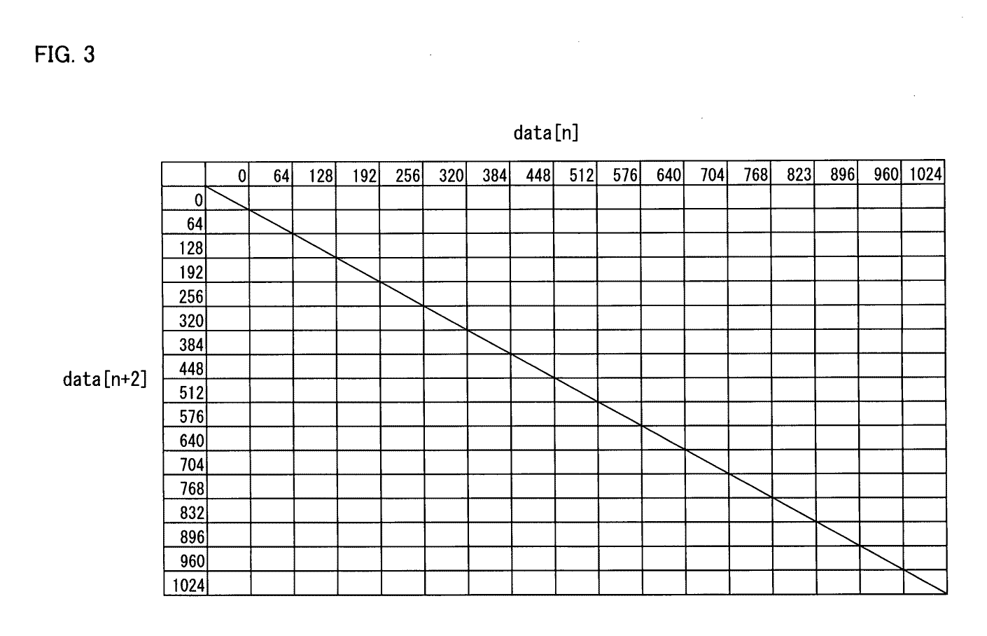

An example of a memory configuration of the LUT is described below with reference to FIG. 3. According to FIG. 3, the LUT 12 has a memory configuration so as to store correction amounts corresponding to respective combinations of representative gray scale levels for the data [n] and representative gray scale levels for the data [n+2]. The correction amounts of FIG. 3 are obtained when the number of gray scales for each pixel data is 1024 (10 bits). In such a memory configuration, both the representative gray scale levels for the data [n] and the representative gray scale levels for the data [n+2] are prepared every 64 gray scales. In other words, 17 representative gray scale levels, which are prepared every 64 gray scale levels, out of the 1024 gray scale levels are allocated to each of the data to be referred to and each of the data to be corrected. The correction amounts are stored in the LUT 12 so as to correspond to all the combinations of the above representative gray scale levels.

The above memory configuration is merely an example. It is possible to appropriately set the number of the representative gray scale levels which are allocated to each of the data to be referred to and each of the data to be corrected. For example, the number of the representative gray scale levels can be 1024, i.e., the representative gray scale levels can be prepared for all the gray scale levels. In this case, it is not necessary to provide any interpolation section 13, although the LUT 12 needs to have larger storage capacity and thus causes a cost increase.

According to the above example, the representative gray scale levels which are allocated to the data to be referred to and the data to be corrected are prepared every predetermined number of gray scale levels (i.e., every 64 gray scale levels). However, the representative gray scale levels do not have to be every fixed number of gray scale levels. For example, the representative gray scale levels can be prepared every smaller number of gray scale levels in the vicinity of gray scale levels where the correction amounts should change finely, whereas the representative gray scale levels can be prepared every greater number of gray scale levels in the other gray scale levels.

In a case where the representative gray scale levels are prepared like above, it is possible to omit the interpolation section 13 by preparing the representative gray scale levels every sufficiently smaller number of gray scale levels. That is, the representative gray scale levels can be prepared so that a correction amount corresponding to a representative gray scale level closest to an actual gray scale level of the pixel data is directly used so as to correct the pixel data.

The liquid crystal display device 1 can be configured so that (i) it further includes a temperature sensor and a plurality of LUTs 12 used at different temperatures and (ii) the interpolation section 13 selectively uses the plurality of LUTs 12 in response to the temperature sensor. The liquid crystal display device 1 configured as above can carry out a correction so as to correspond to a change in drive state of liquid crystal caused by an ambient temperature change. As such, it is possible to maintain high display quality in any temperature environment.

It is also possible to provide a plurality of LUTs 12 in accordance with positional information as to where a pixel whose pixel data is to be corrected is located on a display screen. This allows the interpolation section 13 to selectively use the plurality of LUTs 12 in accordance with the positional information. In this case, it is possible to carry out a correction in response to a change in driving state of liquid crystal caused by a change in location, on the display screen, of the pixel whose pixel data is to be corrected. As such, it is possible to carry out an optimal display on an entire display screen. Besides the above examples, it is also possible to employ an equation for a correlation of correction amounts on the display panel. Alternatively, it is possible to employ another LUT together with the LUT 12. Such another LUT is, for example, an LUT in which multiplying factors are stored. The multiplying factors are prepared so that a multiplying factor of a central part on the display screen is equal to one (1).

### (Detail of Interpolation Process)

The following description discusses, in detail, an interpolation process carried out by the interpolation section 13. As described above, in the LUT 12, the representative gray scale levels are allocated to each of the data to be referred to and each of the data to be corrected. The LUT 12 stores the correction amounts corresponding to the respective combinations of the representative gray scale levels. It follows that, if an actual gray scale level of data does not match any of the representative gray scale levels, then the actual gray scale level has to be subjected to an interpolation so as to find a correction amount.

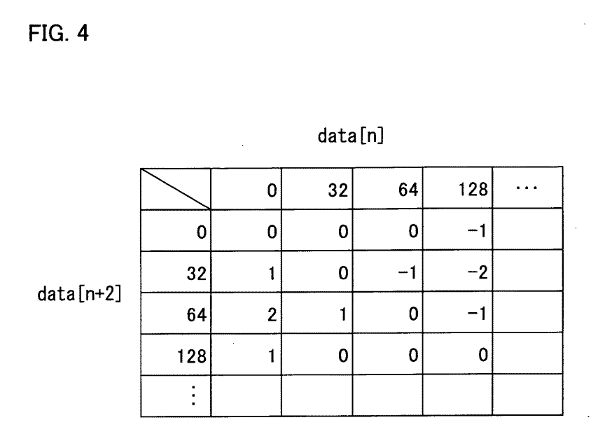

The following description discusses a specific example of the interpolation using an exemplary LUT 12, which is illustrated in FIG. 4. The interpolation is carried out as follows, in a case where the actual gray scale level of the data [n] is 100 and the actual gray scale level of the data [n+2] is 100.

Since the actual gray scale level of the data [n] is 100, a correction amount corresponding to the representative gray scale level “64” for the data [n] and a correction amount corresponding to the representative gray scale level “128” for the data [n] are considered during the interpolation. Likewise, since the actual gray scale level of the data [n+2] is 100, a correction amount corresponding to the representative gray scale level “64” for the data [n+2] and a correction amount corresponding to the representative gray scale level “128” for the data [n+2] are considered during the interpolation. Hereinafter, the description is given on an assumption that a correction amount corresponding to “data [x] to be referred to” and “data [y] to be corrected” in the LUT 12 is represented by “LUT (x, y)”. In a case where the actual gray scale level of the data [n] is 100 and the actual gray scale level of the data [n+2] is 100, the correction amount is found through a linear interpolation using the following four correction amounts: LUT (64, 64), LUT (64, 128), LUT (128, 64), and LUT (128, 128).

First, the linear interpolation is carried out so as to find a correction amount in a case where the actual gray scale level of the data [n] is 64 and the actual gray scale level of the data [n+2] is 100. Specifically, the correction amount is found through the following equation:

LUT(64,100)=LUT(64,64)+(LUT(64,128)−LUT(64,64))*(100−64)/(128−64)=0+(0−0)*36/64=0.

Next, the linear interpolation calculation is carried out so as to find a correction amount in a case where the actual gray scale level of the data [n] is 128 and the actual gray scale level of the data [n+2] is 100. Specifically, the correction amount is found through the following equation:

LUT(128,100)=LUT(128,64)+(LUT(128,128)−LUT(128,64))*(100−64)/(128−64)=−1+(0−(−1))*36/64=−0.4375.

Then, the linear interpolation is carried out with respect to LUT (64, 100) and LUT (128, 100) so as to find LUT (100, 100). Specifically, LUT (100, 100) is found through the following equation:

LUT(100,100)=LUT(64,100)+(LUT(128,100)−LUT(64,100))*(100−64)/(128−64)=0+((−0.4375)−0)*36/64=−0.246.

Note that, if the actual gray scale level of the data is the same as that of the data which was scanned two horizontal scanning lines before, then no correction is necessary. Therefore, the liquid crystal display device 1 can be configured so as to further include a determination section which determines whether or not the interpolation is necessary. If the determination section determines that no interpolation is necessary, then the interpolation as above can be omitted so that no correction is carried out.

According to the above example, the first interpolations are carried out with respect to the correction amounts of the two representative gray scale levels corresponding to the data to be referred to while each data to be corrected is being taken into consideration. Then, the second interpolations are carried out with respect to results of the respective first interpolations while each data to be referred to is being taken into consideration. Alternatively, the following method is applicable. That is, first interpolations are carried out with respect to correction amounts of respective two representative gray scale levels corresponding to data to be corrected while each data to be referred to is being taken into consideration. Then, second interpolations are carried out with respect to results of the respective first interpolations while each data to be corrected is being taken into consideration.

Further, as is clear from the above interpolations, a denominator of each division is a difference value between the representative gray scale levels adjacent to each other. That is, if the interval between the representative gray scale levels adjacent to each other is limited to two's power, then it is possible to carry out a division merely by shifting bits. As such, it is possible to carry out a division by using a simple circuit such as a mere shift register.

### (Flow of Process Performed in Correction Circuit)

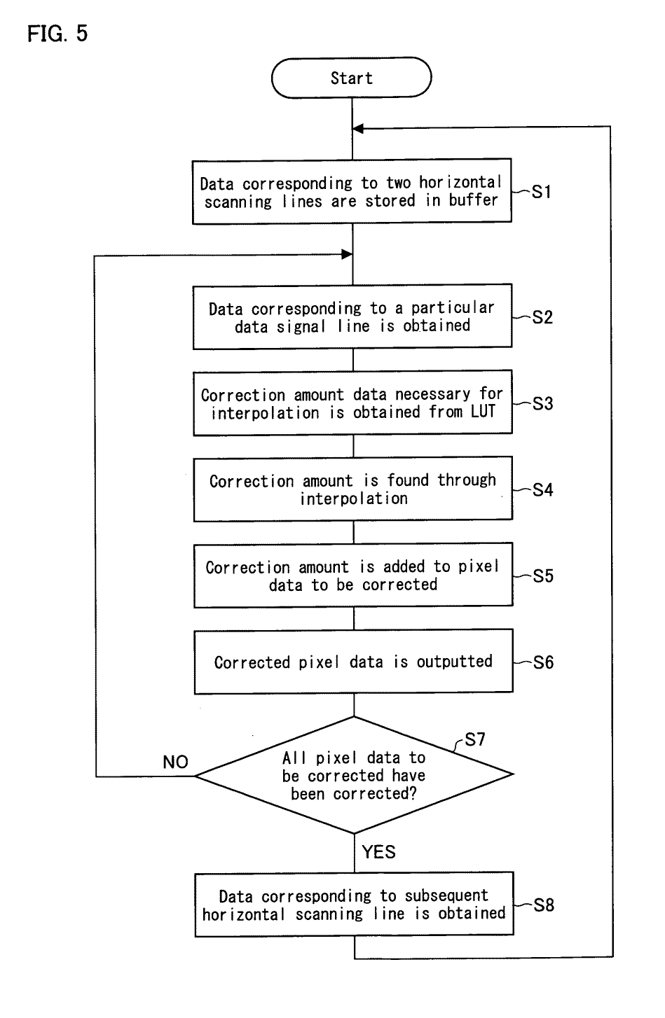

A flow of a process in the correction circuit 10 is described below with reference to the flowchart of FIG. 5.

First, the image signal DATA, which is made up of pieces of data for respective horizontal scanning lines, is supplied from the display control circuit 2 to the correction circuit 10. The pieces of data are sequentially stored in the buffer 11. In this step, pieces of data corresponding to at least two horizontal scanning lines are stored in the buffer 11 (Step 1) (Step x is hereinafter referred to as Sx).

Next in S2, the interpolation section 13 receives, out of the pieces of data corresponding to the two horizontal scanning lines stored in the buffer 11, two pieces of pixel data corresponding to a particular data signal line. The particular data signal line is selected, for example, such that all the data signal lines are sequentially selected from the leftmost data signal line. Out of the two pieces of pixel data received in S2, a piece of pixel data which is first stored in the buffer 11 is “data to be referred to”, whereas a piece of pixel data which is subsequently stored in the buffer 11 is “data to be corrected”.

Next in S3, the interpolation section 13 receives, from the LUT 12, correction amount data necessary for the interpolation, in accordance with the data to be referred to and the data to be corrected. Specifically, the interpolation section 13 carries out the following processes. First, the interpolation section 13 identifies, out of the representative gray scale levels corresponding to the data to be referred to, two representative gray scale levels between which the data to be referred to is positioned. Next, the interpolation section 13 identifies, out of the representative gray scale levels corresponding to the data to be corrected, two representative gray scale levels between which the data to be corrected is positioned. Then, the interpolation section 13 receives, from the LUT 12, all (four) pieces of correction amount data corresponding to respective all (four) pairs of the two representative gray scale levels corresponding to the data to be referred to and the two representative gray scale levels corresponding to the data to be corrected.

Next in S4, the interpolation section 13 carries out interpolations by using the four pieces of correction amount data received in S3, so as to find a correction amount. Specifically, as described earlier, the interpolation section 13 carries out the interpolation as follows. That is, first interpolations are carried out with respect to correction amounts of respective two representative gray scale levels corresponding to the data to be referred to (or the data to be corrected) while each data to be corrected (or the data to be referred to) is being taken into consideration. Then, second interpolations are carried out with respect to results of the respective first interpolations while each data to be referred to (or each data to be corrected) is being taken into consideration. This causes an actual correction amount to be found. The actual correction amount is stored in the correction amount storage section 14.

Next in S5, the adder 15 receives (i) the correction amount from the correction amount storage section 14 and (ii) the pixel data corresponding to the correction amount from the buffer 11. Then, the adder 15 carries out the following addition process. Specifically, the adder 15 receives the correction amount from the correction amount storage section 14 and receives, from the buffer 11, the pixel data serving as the data to be corrected. Then, the adder 15 adds the correction amount to the pixel data.

Next in S6, the adder 15 outputs a result added in S5. Thereafter, the interpolation section 13 checks whether or not all the pixel data, stored in the buffer 11, which are to be corrected, have been corrected (S7). If it is checked that there is pixel data which have not been corrected (NO in S7), then the process in the correction circuit 10 is repeated from S2.

If it is checked that all of the pixel data have been corrected (YES in S7), then the buffer 11 receives data corresponding to next one (1) horizontal scanning line from the display control circuit 2 (S8). Then, the process returns to S1. Specifically, in the buffer 11, (i) the data, corresponding to one (1) horizontal scanning line, which was used as the data to be referred to is abandoned, (ii) the data, corresponding to one (1) horizontal scanning line, which has been corrected is employed as the data to be referred to, and (iii) the data, corresponding to the next one (1) horizontal scanning line, which is transmitted from the display control circuit 2 is stored as the data to be corrected.

By repeating the above process, the image signal DATA, which has been transmitted from the display control circuit 2 to the correction circuit 10, is outputted from the correction circuit 10 as the corrected image signal DATA′.

### (Example of Driving)

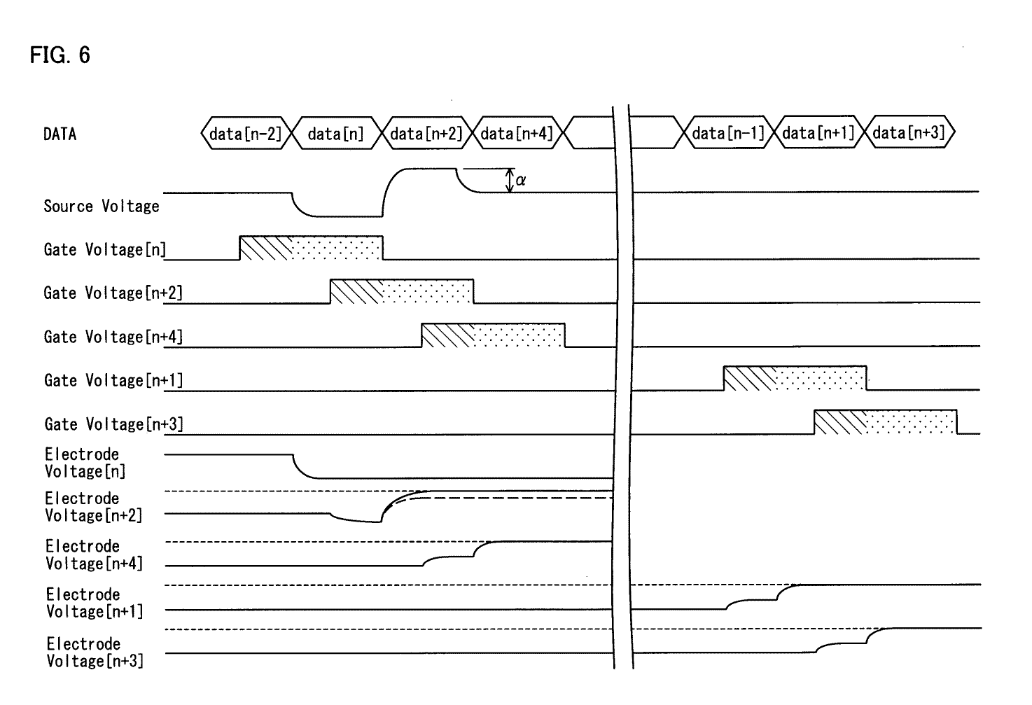

The following description discusses an example of driving for carrying out an actual display, with reference to a timing chart of FIG. 6. FIG. 6 is the timing chart for a certain data signal line, and illustrates (a) timing at which data [i] in an image signal DATA is displayed, (b) a source voltage indicative of an electric potential of the image signal DATA applied to the certain data signal line, (c) a gate voltage [i] indicative of an electric potential of a gate signal applied to an i-th horizontal scanning line, and (d) an electrode voltage [i] indicative of an electric potential of a pixel electrode connected to the i-th horizontal scanning line.

As is clear from FIG. 6, the gate voltage [i] has a gate-on pulse whose rising edge comes earlier than a horizontal scanning period starts during which the data [i] is to be displayed. This indicates that the gate-on pulse includes both a pre-charge period and an actual charge period. Since a gate of a TFT 100 is thus placed in an active state prior to an actual horizontal scanning period, a period, during which the pixel electrodes are charged, is prolonged. Since the pixel electrodes are pre-charged during the pre-charge period, it is possible for the pixel electrodes to be surely charged, within the actual charge period, so as to have a target electric potential, even in a case where the need arises to shorten the horizontal scanning period so as to increase scanning frequency, for example.

It should be noted that the interlacing scanning is employed in the method. Therefore, the image signal DATA is supplied every other horizontal scanning line. That is, the image signal DATA is outputted such that data [n−2], data [n], data [n+2], . . . data [n−1], data [n+1], and so on are sequentially outputted from the display control circuit 2.

The image signal DATA of FIG. 6 is illustrated on an assumption that data corresponding to an n-th gate line only causes a black display, and data corresponding to each of the other gate lines causes a predetermined halftone display (a gray display). If no correction is carried out with respect to such an image signal, as described earlier, the pre-charge period during which the pixel electrodes corresponding to an (n+2)-th gate line are charged is affected by the black display caused by the data corresponding to an n-th gate line. As a result, a target charging cannot be achieved. An electric potential of the pixel electrode charged as above is indicated by the dotted line in the electrode voltage [n+2] of FIG. 6,

In contrast, according to the present embodiment, as described earlier, a correction is carried out with respect to pixel data to be subsequently scanned, in accordance with a relationship between (i) pixel data to be previously scanned and (ii) the pixel data to be subsequently scanned. According to an example of FIG. 6, a correction is carried out with respect to the data [n+2] so that a gray scale level of the data [n+2] is greater than its actual gray scale level, in accordance with a relationship between the pixel data corresponding to the data [n] and the pixel data corresponding to the data [n+2]. With the correction, the source voltage applied while the data [n+2] is being displayed is increased by an amount of α, as compared to the source voltage applied when no correction is carried out.

With such a correction, even if the black display, caused by the data corresponding to the n-th gate line, have an effect on the pre-charge period during which the pixel electrodes corresponding to the (n+2)-th gate line are charged, the electric charging is carried out so as to cancel such an effect of the black display. This makes it possible to appropriately charge the pixel electrodes corresponding to the (n+2)-th gate line so that the pixel electrodes have a target electric potential.

### (Another Example of Driving)

The following description discusses an example employing a driving method other than the above driving method.

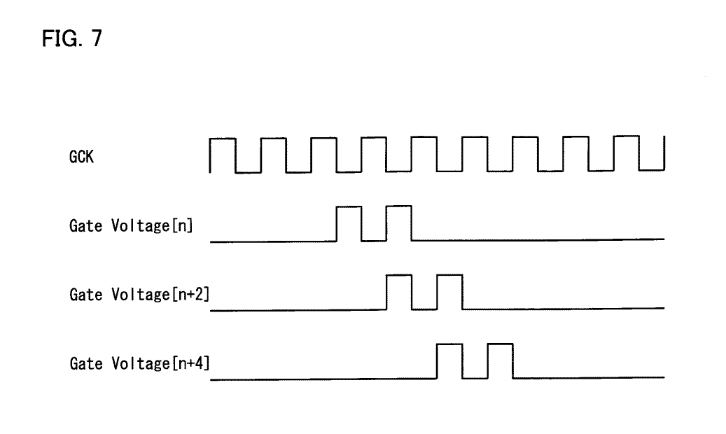

FIG. 7 illustrates a gate clock GCK and a gate voltage [i] indicative of an electric potential of a gate signal to be applied to an i-th horizontal scanning line, which are observed when pieces of data are similarly supplied, by the interlacing scanning, as the image signal DATA every other horizontal scanning line in the interlacing scanning. According to the example described earlier, each gate-on pulse contains both the pre-charge period and the actual charge period. In contrast, according to the example of FIG. 7, a gate-on pulse corresponding to the pre-charge period and a gate-on pulse corresponding to the actual charge period are separately applied as two independent pulses. This corresponds to a case where the gate driver 4 generates a gate-on pulse in synchronization with a pulse width of the gate clock GCK.

According to the example of FIG. 7, the gate-on pulse turns ON in synchronization with a falling edge of the gate clock GCK, and the gate-on pulse turns OFF in synchronization with a rising edge of the gate clock GCK. That is, the pre-charge period and the actual charge period realized by respective independent pulses between which a pulse width equal to a pulse width of the gate clock GCK is provided. According to the example, the gate-on pulse of the pre-charge period corresponding to the (n+2)-th gate line is applied at the same timing as that of the actual charge period corresponding to the n-th gate line. As such, the pre-charge period for the pixel electrodes corresponding to the (n+2)-th gate line is affected by the actual charge period for the pixel electrodes corresponding to the n-th gate line. In view of this, it is also advantageous to carry out the correction as described earlier.

According to the example of FIG. 7, as described above, the gate-on pulse corresponding to the pre-charge period and the gate-on pulse corresponding to the actual charge period are applied as respective independent pulses. On the other hand, according to the example of FIG. 6, one (1) gate-on pulse contains both the pre-charge period and the actual charge period. Out of these examples, the example of FIG. 6 is capable of reducing the number of times a signal voltage applied to a gate line changes. As such, the example of FIG. 6 makes it possible to reduce frequency of the signal, thereby reducing electric power consumption.

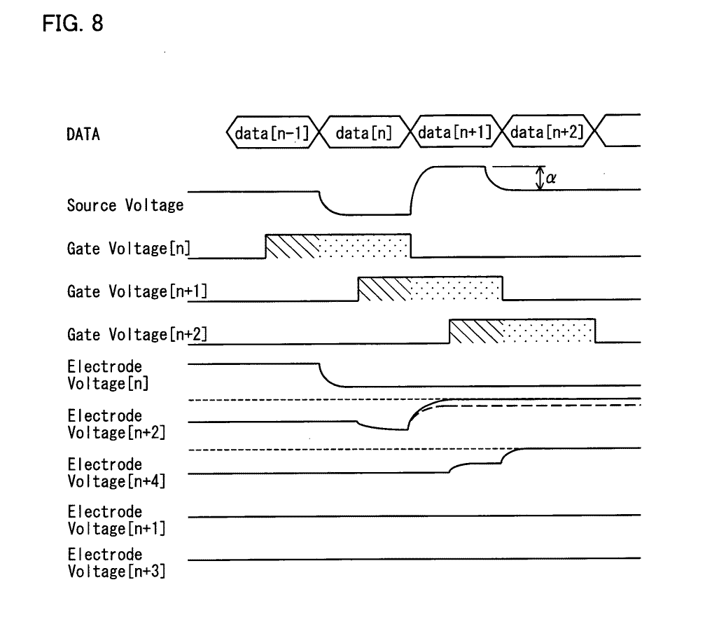

FIG. 8 illustrates an exemplary timing chart obtained when driving is carried out by the progressive scanning. FIG. 8 is illustrated so as to follow the timing chart of FIG. 6. That is, according to FIG. 8, the gate-on pulse contains both the pre-charge period and the actual charge period.

The example of FIG. 8 employs the progressive scanning. Therefore, according to the image signal DATA, pieces of data corresponding to the respective horizontal scanning lines are supplied. That is, according to the image signal DATA, data [n−1], data [n], data [n+1], and so on are sequentially outputted, in this order, from the display control circuit 2.

The image signal DATA of FIG. 8 is illustrated on an assumption that data corresponding to an n-th gate line only causes a black display, and data corresponding to each of the other gate lines causes a predetermined halftone display (a gray display). If no correction is carried out with respect to such an image signal, as described earlier, the pre-charge period during which the pixel electrodes corresponding to the (n+1)-th gate line are charged is affected by the black display caused by the data corresponding to the n-th gate line. As a result, a target charging cannot be achieved. An electric potential of the pixel electrodes charged as above is indicated by the dotted line in the electrode voltage [n+1] of FIG. 8.

In contrast, according to the present embodiment, as described earlier, a correction is carried out with respect to pixel data to be subsequently scanned, in accordance with a relationship between (i) pixel data to be previously scanned and (ii) the pixel data to be subsequently scanned. According to an example of FIG. 8, a correction is carried out with respect to the data [n+1] so that a gray scale level of the data [n+1] is greater than its actual gray scale level, in accordance with a relationship between the pixel data corresponding to the data [n] and the pixel data corresponding to the data [n+1]. With this correction, the source voltage applied while the data [n+1] is being displayed is increased by an amount of α, as compared to the source voltage applied when no correction is carried out.

With such a correction, even if the black display, caused by the data corresponding to the n-th gate line, have an effect on the pre-charge period during which the pixel electrodes corresponding to the (n+1)-th gate line are charged, the electric charging is carried out so as to cancel such an effect of the black display. This makes it possible to appropriately charge the pixel electrodes corresponding to the (n+1)-th gate line so that the pixel electrodes have a target electric potential.

The example of FIG. 8 is illustrated on an assumption that that a frame reversal driving is employed. That is, the example of FIG. 8 is illustrated on the assumption that an AC driving (inversion driving), in which polarity of a voltage applied to the liquid crystal layer is reversed for every one frame, is employed. Therefore, during one (1) frame, a first voltage, to be applied to first pixel electrodes connected to one of any adjacent gate lines, has a polarity identical to that of a second voltage to be applied to second pixel electrodes connected to the other of the any adjacent gate lines. As such, it is possible to continuously provide the pre-charge period and the actual charge period.

On the other hand, in a case where a line reversal driving is employed, i.e., in a case where an AC driving, in which polarity of a voltage to be applied to the liquid crystal layer is reversed for every one (1) horizontal scanning line, is employed, a first voltage, to be applied to first pixel electrodes connected to one of any adjacent gate lines, has a polarity reverse to that of a second voltage to be applied to second pixel electrodes connected to the other of the any adjacent gate lines. Therefore, unlike the frame reversal driving, it is not possible to continuously provide the pre-charge period and the actual charge period.

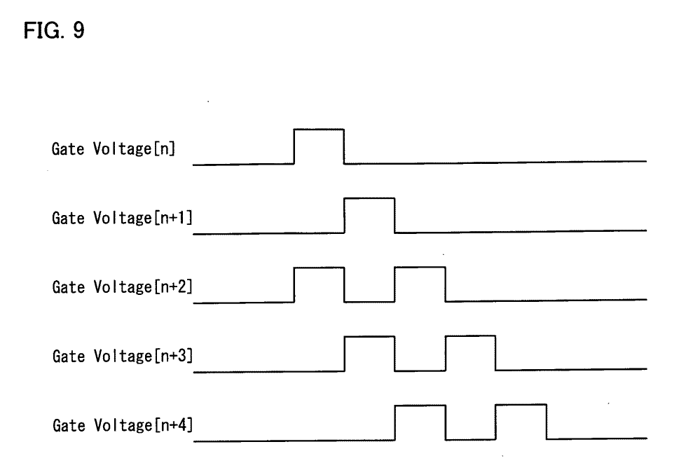

FIG. 9 illustrates a gate voltage [i] which is applied to an i-th horizontal scanning line, observed when the progressive scanning, in which the line reversal driving is carried out, is employed. According to FIG. 9, n-th, (n+2)-th, and (n+4)-th gate lines have a first identical polarity, whereas (n+1)-th and (n+3)-th gate lines have a second identical polarity which is opposite to the first polarity. In this case, a pre-charge period is set so that timing of the pre-charge period corresponding to a gate line matches that of an actual charge period corresponding to a gate line which comes two horizontal scanning lines before. During the pre-charge period and the actual charge period, voltages having an identical polarity are applied to the respective gate lines. This makes it possible to achieve a sufficient precharge. That is, as is the case for those described earlier, the pre-charge period for the pixel electrodes corresponding to the (n+2)-th gate line is affected by the actual charge period for the pixel electrodes corresponding to the n-th gate line. In view of this, it is also advantageous to carry out the correction as described earlier.

Further, the gate voltage is set to zero during the actual charge period corresponding to a gate line which comes one (1) horizontal scanning line before and which receives a voltage having an opposite polarity. This makes it possible to effectively carry out the pre-charge without being affected by applying the voltages having respective opposite polarities to the respective gate lines.

### (Arrangement Example of Correction Circuit)

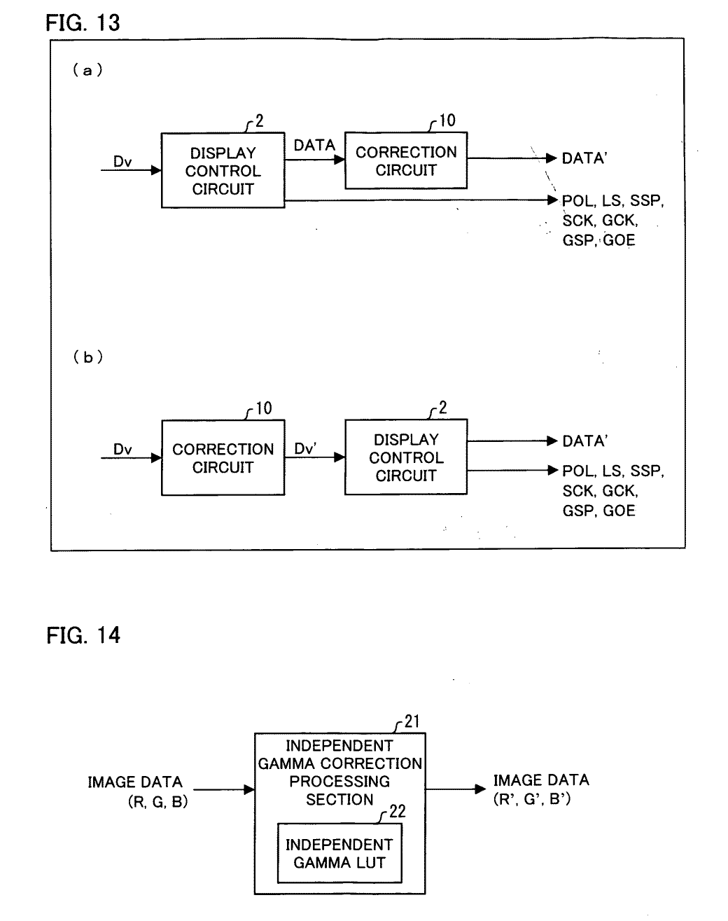

According to the configurations as above, the correction circuit 10 corrects the image signal DATA, which is supplied from the display control circuit 2, and then supplies the corrected image signal DATA′ to the source driver 3. This is schematically illustrated in (a) of FIG. 13.

On the other hand, the correction circuit 10 can be configured so as to (i) correct an externally supplied digital video signal Dv and (ii) output a corrected digital video signal Dv′ to the display control circuit 2. This is schematically illustrated in (b) of FIG. 13.

Thus, the correction circuit 10 can be configured so as to correct an image signal which has been subjected to a display control by the display control circuit 2. Alternatively, the correction circuit 10 can be configured so as to correct a digital video signal which has not been subjected to the display control by the display control circuit 2. Note, however, that attention should be given when an independent gamma correction is carried out by the display control circuit 2. This is described below in detail.

The independent gamma correction refers to a gamma correction which is carried out for each color component so as to compensate for wavelength dependence of a V-T curve. The V-T curve indicates a relationship between a voltage applied to the liquid crystal layer and optical transmittance of the liquid crystal layer. A general gamma correction is for achieving an appropriate relationship between a change in the input gray scale level and actual optical transmittance, by specifying an output gray scale level for each input gray scale level. On the other hand, in the independent gamma correction, this process is carried out for each of color components R, G, and B.

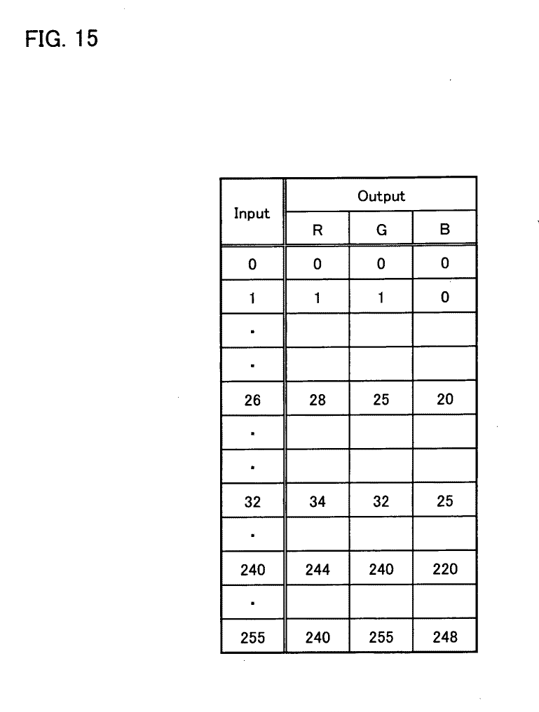

FIG. 14 schematically illustrates an independent gamma correction processing section 21. As illustrated in FIG. 14, the independent gamma correction processing section 21 includes an independent gamma LUT 22. FIG. 15 illustrates a specific example of the independent gamma LUT 22. As illustrated in FIG. 15, the independent gamma LUT 22 is a table indicative of input gray scale levels (in FIG. 15, the gray scale levels are 0 through 255) and corresponding output gray scale levels for each of the color components R, G, and B.

The independent gamma correction processing section 21 receives image data (R, G, B), containing the color components R, G, and B, which has not been corrected by the independent gamma correction. The independent gamma correction processing section 21 then extracts, as an input gray scale level, data of each of the color components from the image data (R, G, B). Then, the independent gamma correction processing section 21 identifies a corresponding output gray scale level for each of the color components, with reference to the independent gamma LUT 22. The output gray scale levels for the respective color components are outputted as image data (R′, G′, B′) which has been corrected by the independent gamma correction.

Basically, the independent gamma correction as above is carried out in the display control circuit 2. That is, the display control circuit 2 includes the independent gamma correction processing section 21. However, alternatively, the independent correction processing section 21 can be provided independently of the display control circuit 2.

The following description discusses how the process changes depending on the order of (i) timing at which the independent gamma correction is carried out by the independent gamma correction processing section 21 and (ii) timing at which the above correction is carried out by the correction circuit 10. Hereinafter, the correction carried out by the correction circuit 10 is referred to as a ghost correction.

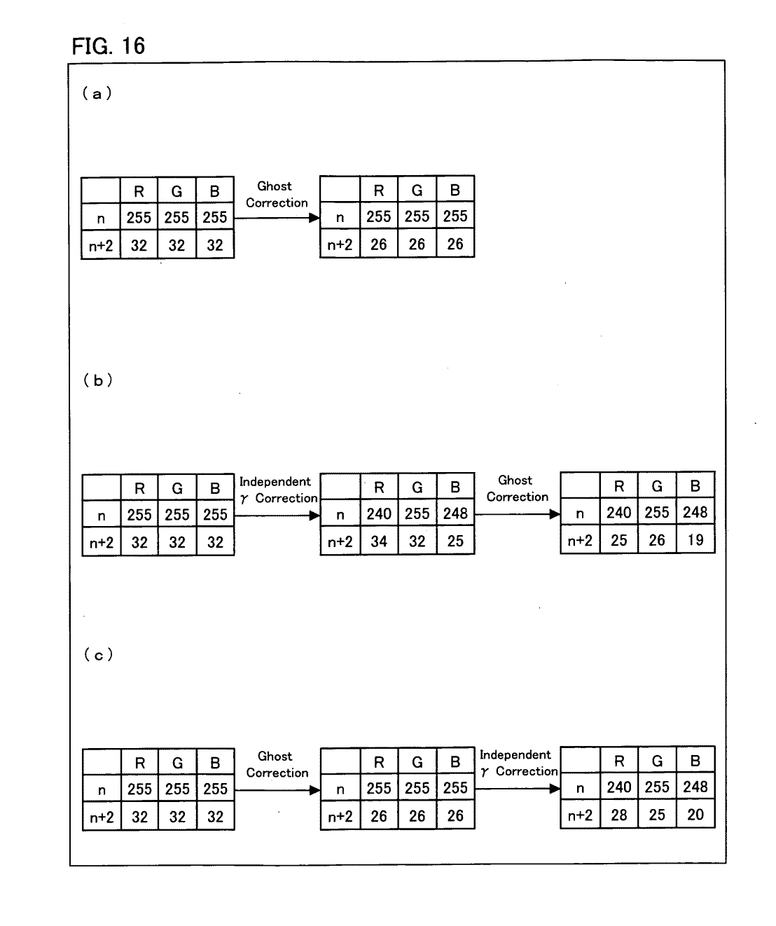

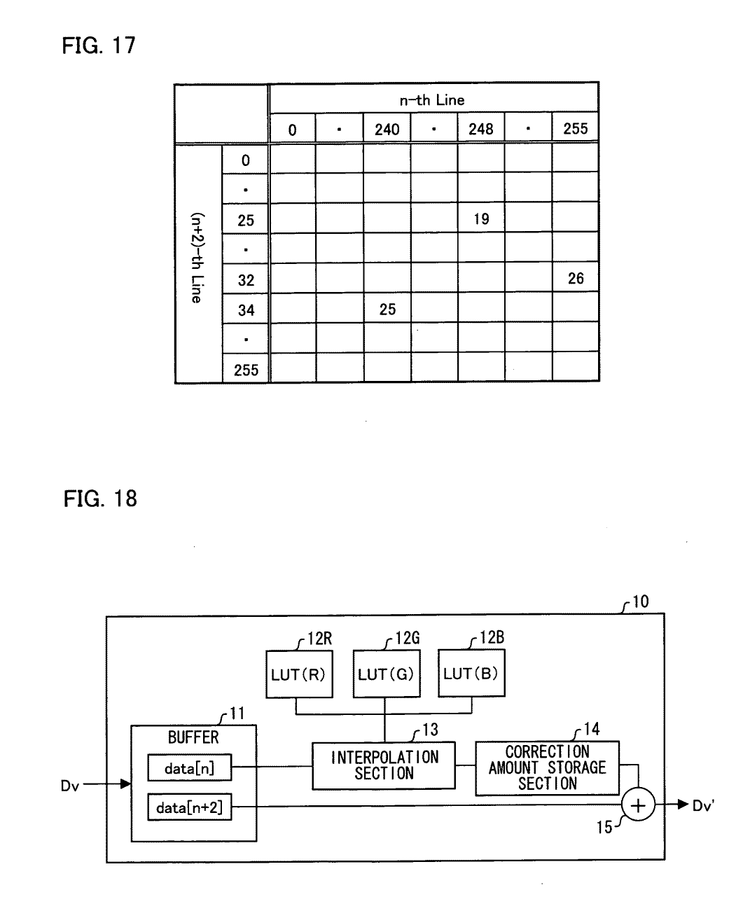

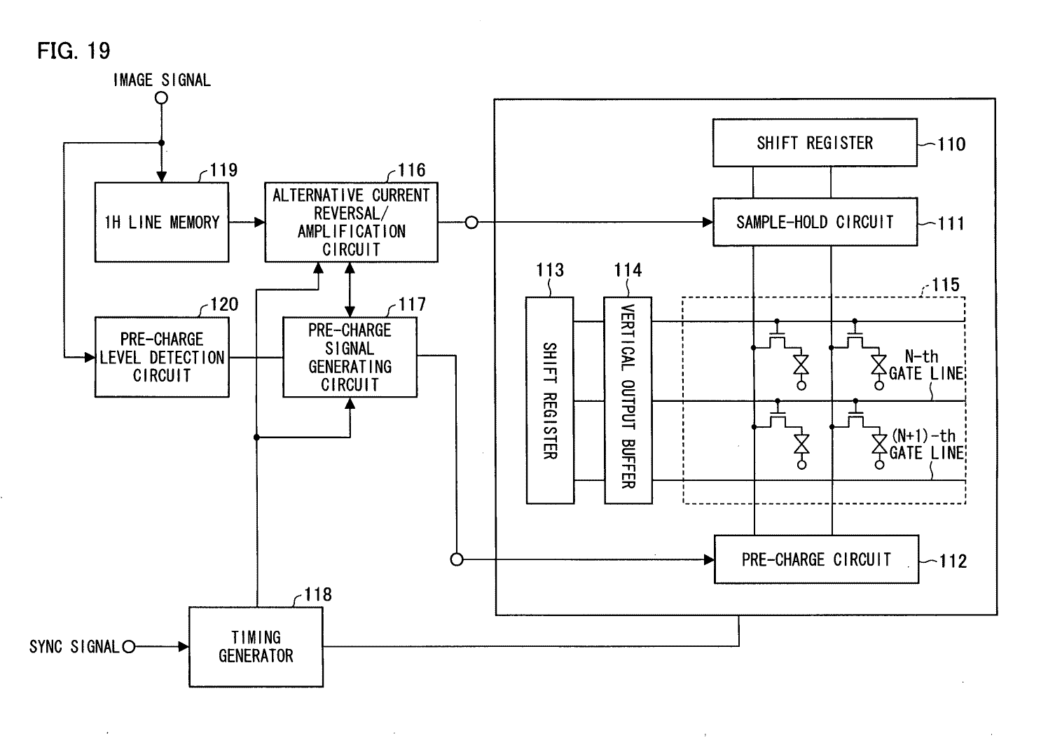

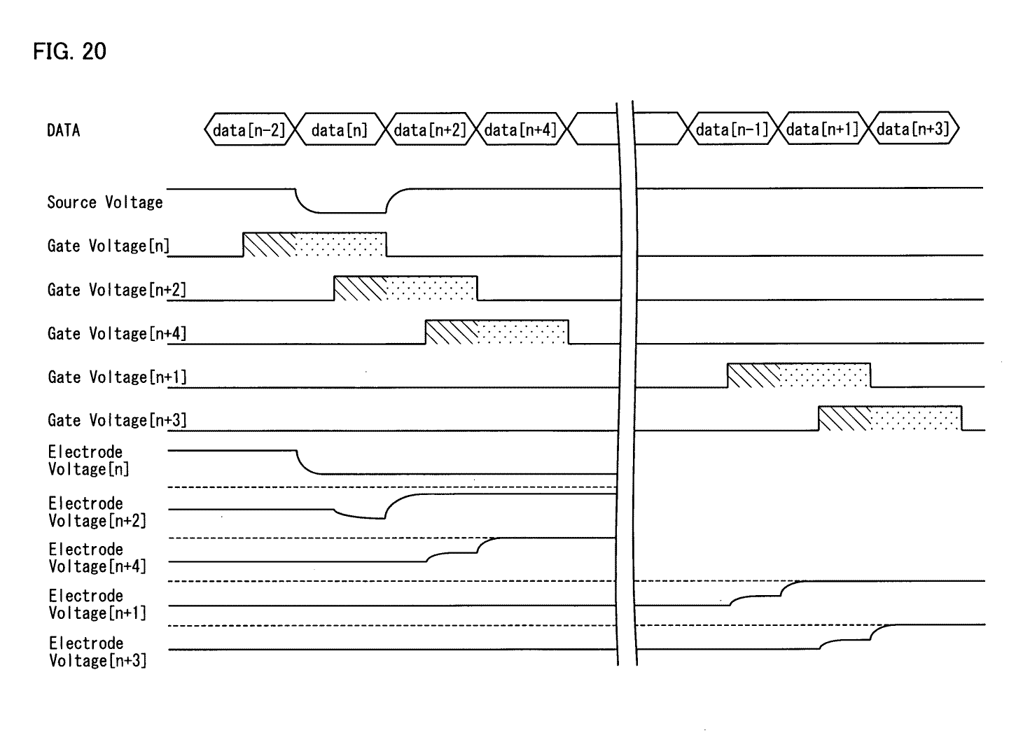

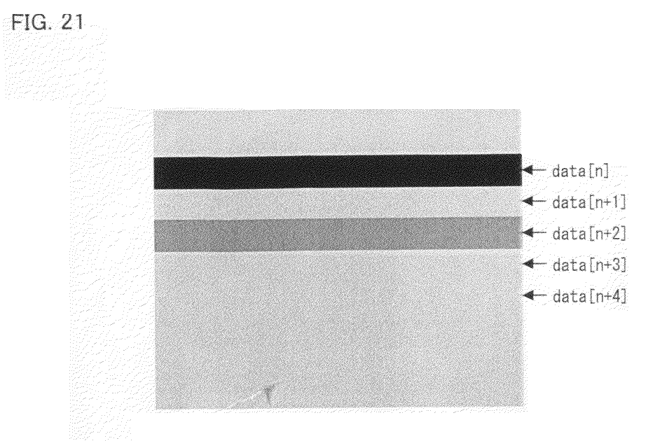

(a) of FIG. 16 illustrates an example of numeric values obtained when the ghost correction only is carried out with respect to exemplary pieces of image data (R, G, B) for n-th and (n+2)-th gate lines, without carrying out the independent gamma correction. According to the example, gray scale levels of the image data (R, G, B) for the n-th gate line are (255, 255, 255), whereas gray scale levels of the image data (R, G, B) for the (n+2)-th gate line are (32, 32, 32). In a case where the LUT 12 of the correction circuit 10 is a table illustrated in FIG. 17, the gray scale levels of the image data (R, G, B) for the (n+2)-th line are corrected so as to be (26, 26, 26) by the correction circuit 10 carrying out the ghost correction. This causes cancellation of a display defect called “ghost”.

(b) of FIG. 16 illustrates an example of numeric values obtained when the independent gamma correction and the ghost correction are carried out in this order with respect to exemplary image data (R, G, B) for n-th and (n+2)-th gate lines. According to the example, gray scale levels of the image data (R, G, B) for n-th gate line are (255, 255, 255), whereas gray scale levels of the image data (R, G, B) for the (n+2)-th gate line are (32, 32, 32). When, the independent gamma correction are carried out with reference to the independent gamma LUT 22 of FIG. 15, (i) the gray scale levels of the image data (R, G, B) for n-th gate line are corrected, so as to be (240, 255, 248) and (ii) the gray scale levels of the image data (R, G, B) for (n+2)-th gate line are corrected so as to be (34, 32, 25). The ghost correction is subsequently carried out with reference to the LUT 12 of FIG. 17. This causes the gray scale levels of the image data (R, G, B) for the (n+2)-th line to be corrected so as to be (25, 26, 19). Thus, the display defect called “ghost” are cancelled. That is, in a case where the independent gamma correction and the ghost correction are carried out in this order, advantages of both the independent gamma correction and the ghost correction are appropriately achieved.

(c) of FIG. 16 illustrates an example of numeric values obtained when the ghost correction and the independent gamma correction are carried out in this order with respect to exemplary image data (R, G, B) for n-th and (n+2)-th lines. According to the example, gray scale levels of the image data (R, G, B) for the n-th gate line are (255, 255, 255), whereas gray scale levels of the image data (R, G, B) for the (n+2)-th line are (32, 32, 32). With the ghost correction carried out with reference to the LUT 12 of FIG. 17, the gray scale levels of the image data (R, G, B) for the (n+2)-th line are corrected so as to be (26, 26, 26). With the subsequent independent gamma correction carried out with reference to the independent gamma LUT 22 of FIG. 15, the gray scale levels of the image data (R, G, B) for the n-th line are corrected so as to be (240, 255, 248), and the gray scale levels of the image data (R, G, B) for the (n+2)-th line are corrected so as to be (28, 25, 20). In this case, the image data in which the ghost has been canceled by the ghost correction is further corrected by the independent gamma correction. This causes an occurrence of another ghost in the image data.

That is, in a case where the independent gamma correction is carried out in the display control circuit 2, a circuit configuration such as that illustrated in (a) of FIG. 13 allows both the independent gamma correction and the ghost correction to be appropriately carried out. According to such a circuit configuration, the correction circuit 10 carries out the ghost correction with respect to the image signal DATA supplied from the display control circuit 2. On the other hand, it is not possible for the ghost correction to be appropriately carried out, in a case of a circuit configuration such as that illustrated in (b) of FIG. 13, i.e., a circuit configuration in which the corrected digital video signal Dv′, to which the correction circuit 10 has carried out the ghost correction, is supplied to the display control circuit 2.

In the case of an arrangement in which the ghost correction and the independent gamma correction are carried out in this order, the above problem can be solved by configuring a correction circuit 10 as illustrated in FIG. 18. Specifically, according to such a correction circuit 10, LUTs 12R, 12G, and 12B are provided so as to correspond to the color components of R, G, and B, respectively. This allows independent corrections for the respective color components RGB. Further, each of the LUTs 12R, 12G, and 12B is prepared so as to contain numeric values which are set in consideration of the subsequent independent gamma correction. This allows both the independent gamma correction and the ghost correction to be appropriately carried out, even in the case where the ghost correction and the independent gamma correction are carried out in this order. A correction and an interpolation in this arrangement are carried out in the same manners as those described earlier. Therefore, the descriptions for such correction and interpolation are omitted here.

The correction circuit 10 configured as illustrated in FIG. 18 is applicable to either the interlacing scanning or the progressive scanning.

### (Another Circuit Configuration Example of Correction Circuit)

According to the above circuit configuration, the correction circuit 10 carries out the correction process by causing the interpolation section 13 to carry out the interpolation with reference to the LUT 12. The present embodiment is not limited to the circuit configuration. Alternatively, the correction circuit 10 can have a circuit configuration in which a correction finding processing section is provided for carrying out a correction by use of a function. In the case of such a circuit configuration, specifically, the correction finding processing section first receives, from the buffer 11, data to be referred to and data to be corrected. Next, the correction finding processing section assigns, to a predetermined function, the data to be referred to and the data to be corrected, so as to find a correction amount. The correction amount is stored in the correction amount storage section 14. The subsequent processes are the same as those described earlier.

### (Configuration of Television Receiver)

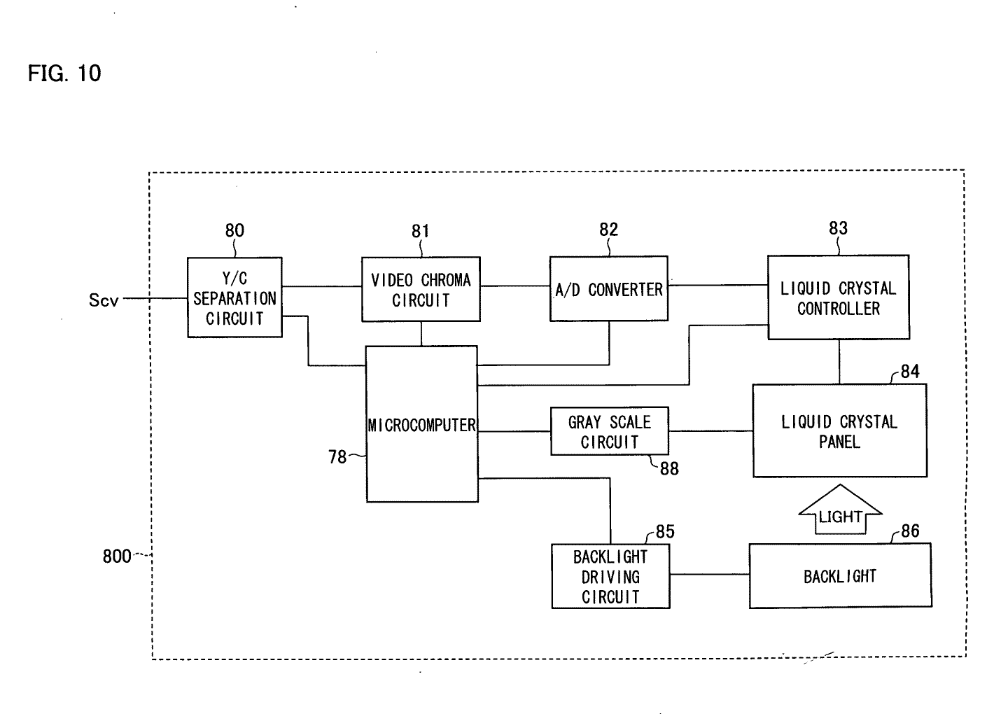

The following description discusses an example of a liquid crystal display device, in accordance with the present invention, which is applied to a television receiver. FIG. 10 is a block diagram illustrating a configuration of a display device 800 for such a television receiver. The display device 800 includes: a Y/C separation circuit 80; a video chroma circuit 81; an A/D converter 82; a liquid crystal controller 83; a liquid crystal panel 84; a backlight driving circuit 85; a backlight 86; a microcomputer 87; and a gray scale circuit 88. The liquid crystal panel 84 corresponds to the liquid crystal display device of the present invention. The liquid crystal display panel 84 includes (i) a display section constituted by pixel array provided in a matrix manner and (ii) a source driver and a gate driver for driving the display section.

According to the display device 800 configured as above, first, a composite color video signal Scv, serving as a television signal, is externally supplied to the Y/C separation circuit 80. Then, the Y/C separation circuit 80 separates the composite color video signal Scv to a brightness signal and a color signal. The brightness signal and the color signal are converted, in the video chroma circuit 81, to an analog RGB signal corresponding to three primary colors of light. The analog RGB signal is further converted to a digital RGB signal by the A/D converter 82. The digital RGB signal is then supplied to the liquid crystal controller 83. Meanwhile, the Y/C separation circuit 80 extracts horizontal and vertical sync signals from the composite color video signal Scv which is externally supplied. The horizontal and vertical sync signals are also supplied to the liquid crystal controller 83 via the microcomputer 87.

The liquid crystal controller 83 outputs a driver data signal in response to the digital RGB signal (corresponding to the digital video signal Dv described earlier) supplied from the A/D converter. The liquid crystal controller 83 further generates, in response to the horizontal and vertical sync signals, timing control signals for driving the source driver and the gate driver in the liquid crystal panel 84 in the same manner as described in the embodiment. Then, the liquid crystal controller 83 supplies the timing control signals to the source driver and the gate driver. The gray scale circuit 88 generates gray scale voltages for the respective three primary colors R, G, B of a color display, and then supplies the gray scale voltages to the liquid crystal panel 84.

The liquid crystal panel 84 causes (i) members such as the source driver and the gate driver to generate drive signals (a data signal, a scanning signal, etc.), in response to the driver data signal, the timing control signals, and the gray scale voltages and (ii) displays a color image on its incorporated display section to display a color image in response to the drive signals. In order for the liquid crystal panel 84 to display an image, the liquid crystal panel 84 has to be backlit. According to the display device 800, the microcomputer 87 controls the backlight driving circuit 85 to drive the backlight 86 so that a back surface of the liquid crystal panel 25, 84 is irradiated.

The microcomputer 87 carries out not only the above processes but also the control of a whole system. In addition, the video signal (composite color video signal) which is externally supplied is not limited to a video signal of television broadcasting, and can therefore be a video signal such as a video signal taken with a camera or a video signal supplied over the Internet. The display device 800 is thus capable of displaying an image based on a variety of video signals.

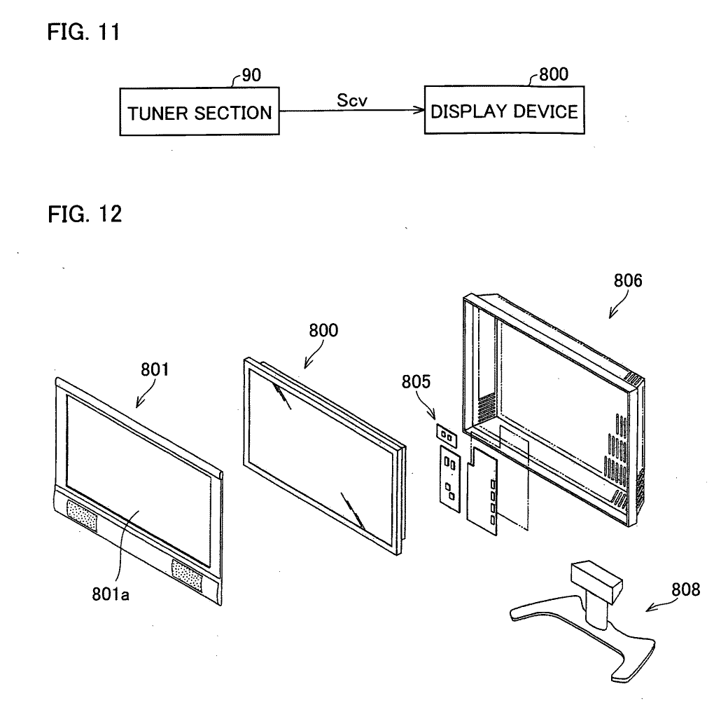

In a case where the display device 800 displays an image based on the television broadcasting, the display device 800 is connected with a tuner section 90 (see FIG. 11). The tuner section 90 extracts, from a wave (a high-frequency signal) received via an antenna (not illustrated), a signal of a channel to be received. The tuner section 90 then converts the signal to an intermediate frequency signal. Then, the tuner section 90 detects the intermediate frequency signal so as to extract the composite color video signal Scv serving as the television signal. The composite color video signal Scv is supplied to the display device 800 as described earlier. The display device 800 then displays an image based on the composite color video signal Scv.

FIG. 12 is an exploded perspective view illustrating an example of a mechanical configuration of a television receiver employing the display device configured as above. According to the example of FIG. 12, the television receiver is constituted by the display device 800, a first housing 801, and a second housing 806. The display device 800 is arranged so as to be sandwiched between and held by the first housing 801 and the second housing 806. The first housing 801 has an opening 801a for transmitting an image to be displayed on the display device 800. The second housing 806 covers a backside of the display device 800, and includes an operation circuit 805 for handling the display device 800. Further, the second housing 806 is supported by a support member 808 at the bottom.

The present invention is not limited to the descriptions of the respective embodiments, but may be altered within the scope of the claims. An embodiment derived from a proper combination of technical means disclosed in different embodiments is encompassed in the technical scope of the invention.

Note that the descriptions of the present embodiments discuss respective configurations in each of which the data signal lines extend in a column direction whereas the scanning signal lines extend in a line direction, for the sake of easy description. However, it is needless to say that a configuration obtained by rotating the screen by 90 degrees, or the like, is also encompassed in the scope of the present invention.

### INDUSTRIAL APPLICABILITY

A liquid crystal display device of the present invention is applicable to a variety of display devices such as a monitor of a personal computer and a television receiver.

1. A data processing device for correcting an image signal which (i) is made up of plural pieces of pixel data and (ii) is externally supplied to an active matrix liquid crystal driving panel,
the active matrix liquid crystal driving panel including: a plurality of scanning signal lines extending in a line direction; a plurality of data signal lines extending in a column direction; and a plurality of pixels provided for respective intersections of the plurality of the scanning signal lines and the plurality of data signal lines,
said data processing device, comprising:
a correction processing section for (i) obtaining first pixel data to be corrected and second pixel data which is for use in driving one of the plurality of data signal lines at timing earlier than timing at which the one of the plurality of data signal lines is driven in response to the first pixel data and (ii) correcting the first pixel data in accordance with a relationship between the second pixel data and the first pixel data.

2. The data processing device according to claim 1, wherein:
the liquid crystal driving panel charges corresponding ones of the plurality of pixels during (i) an actual charge period during which one of the plurality of scanning signal lines is being selectively driven so that corresponding ones of the plurality of pixels each receive, based on the first pixel data, a voltage from the one of the plurality of data signal lines, and (ii) a pre-charge period during which the one of the plurality of scanning signal lines is being selectively driven and which pre-charge period comes earlier than the actual charge period, and
the second pixel data is data to be used when the one of the plurality of data signal lines is driven during the pre-charge period.

3. The data processing device according to claim 1, wherein:
the liquid crystal driving panel is driven by an interlacing scanning in which (i) the plurality of scanning signal lines are divided into two groups so as to belong to an identical group every other horizontal scanning line and (ii) the two groups are sequentially scanned, and
the second pixel data is data to drive pixels corresponding to a (n−2)-th scanning signal line, where a scanning signal line is an n-th scanning signal line corresponding to pixels which are driven in response to the first pixel data.

4. The data processing device according to claim 1, further comprising:
a correction amount storage section for storing correction amount data each corresponding to a combination of the second pixel data and first pixel data,
the correction processing section carrying out a correction with reference to the correction amount data stored in the correction amount storage section.

5. The data processing device according to claim 4, wherein:
the correction amount storage section stores the correction amount data which correspond to combinations of a plurality of representative gray scale levels corresponding to the second pixel data and a plurality of representative gray scale levels corresponding to the first pixel data, and
the correction processing section finds a correction amount by (i) identifying, out of the plurality of representative gray scale levels corresponding to the second pixel data, two representative gray scale levels between which the second pixel data obtained is positioned, (ii) identifying, out of the plurality of representative gray scale levels corresponding to the first pixel data, two representative gray scale levels between which the first pixel value obtained is positioned, and (iii) carrying out an interpolation with respect to correction amount data corresponding to combinations of the two representative gray scale levels for the second pixel data and the two representative gray scale levels for the first pixel data.

6. A liquid crystal display device comprising:
an active matrix liquid crystal driving panel including: a plurality of scanning signal lines extending in a line direction, a plurality of data signal lines extending in a column direction, and a plurality of pixels provided for respective intersections of the plurality of scanning signal lines and the plurality of data signal lines;
a scanning signal driving section for sequentially applying a gate-on pulse to the plurality of scanning signal lines so as to selectively drive the plurality of scanning signal lines;
a data signal driving section for applying a data signal to the plurality of data signal lines so that polarity of the data signal is reversed for every predetermined number of horizontal periods during one frame period; and
a data processing device recited in claim 1.

7. The liquid crystal display device according to claim 6, further comprising:
a display control circuit for (i) receiving an image signal which is made up of plural pieces of pixel data and is externally supplied and (ii) outputting (a) signals for controlling operations of the scanning signal driving section and the data signal driving section and (b) an image signal to be supplied to the data signal driving section,
the data processing device correcting the image signal outputted from the display control circuit so as to supply a corrected image signal to the data signal driving section.

8. The liquid crystal display device according to claim 6, further comprising:
a display control circuit for (i) receiving an image signal which is made up of plural pieces of pixel data and is externally supplied and (ii) outputting (a) signals for controlling operations of the scanning signal driving section and the data signal driving section and (b) a image signal to be supplied to the data signal driving section,
the data processing device correcting the image signal supplied to the display control circuit.

9. The liquid crystal display device according to claim 8, wherein the display control circuit carries out a gamma correction independently for each color component of the image signal,
the liquid crystal display device further comprising:
a correction amount storage section for storing, independently for each color component, correction amount data corresponding to a combination of second pixel data and first pixel data,
the correction amount storage section carrying out correction with reference to the correction amount data stored in the correction amount storage section.

10. A television receiver comprising:
a liquid crystal display device recited in claim 6; and
a tuner section for receiving television broadcasting.

11. A data processing method for correcting an image signal which (i) is made up of plural pieces of pixel data and (ii) is externally supplied to an active matrix liquid crystal driving panel,
the active matrix liquid crystal panel including: a plurality of scanning signal lines extending in a line direction; a plurality of data signal lines extending in a column direction; and a plurality of pixels provided for respective intersections of the plurality of the scanning signal lines and the plurality of data signal lines,
said method comprising the steps of:
obtaining first pixel data to be corrected and second pixel data which is for use in driving one of the plurality of data signal lines at timing earlier than timing at which the one of the plurality of data signal lines is driven in response to the first pixel data; and
correcting the first pixel data in accordance with a relationship between the second pixel data and the first pixel data.
